(19) United States
(12) Patent Application Publication
(10) Pub. No.: US 2017/0004712 A1
(43) Pub. Date: Jan. 5, 2017

(54) Regional electric vehicle sharing and management system and method

(71) Applicant: Cheng-Hsien Yang, New Taipei City (TW)

(72) Inventor: Cheng-Hsien Yang, New Taipei City (TW)

(21) Appl. No.: 15/264,621

(22) Filed: Sep. 14, 2016

(30) Foreign Application Priority Data
Jul. 25, 2016 (TW) 105123487

(51) Int. Cl. G08G 1/00; G06Q 30/06; H04L 29/08; G07C 5/00

(52) U.S. Cl. CPC G08G 1/202; G08G 1/207; G07C 5/008; G06Q 30/0645; H04L 67/12

(57) ABSTRACT

A regional electric vehicle sharing and management system includes a system backup server connected to a system management server via an Intranet wherein both the system management server and the system backup server are configured to access the Internet via the Intranet; mobile devices, each configured to access the Internet via a telecommunications network or a wireless network; computers, each configured to access the Internet via a wired network or a wireless network; battery exchange devices, each including batteries, a charging circuit, and a power monitoring system wherein the batteries, the charging circuit, and the power monitoring system are electrically connected together, and the batteries are respectively mounted in the charging circuit; and electric vehicles, each including batteries and vehicle control systems they are electrically connected together. A regional electric vehicle sharing and management method is also provided.

### BACKGROUND OF THE INVENTION

1. Field of the Invention

The invention relates to a regional electric vehicle sharing and management systems, and more particularly to a regional electric vehicle sharing and management system which is capable of allocation and dispatching of electric vehicles among different regions with time and quantitative restrictions by offering users free-of-charge or low-rate renting privileges and a regional electric vehicle sharing and management method.

2. Description of Related Art

At present, in most of the metropolitan areas of the world, there are bus transportation networks, mass rapid transit systems or private taxis to meet the need of public consumers for transportation between different places within the metropolitan areas. However, due to enormous population in the metropolitan areas, there are too many vehicles traveling in the streets and traffic jams occur frequently. Therefore, when taking buses or taxis, people always suffer from traffic jams. Mass rapid transit systems are fast and convenient, and can avoid the problem of traffic jams. Nonetheless, they are only suitable for traveling to places where people can reach by walking from the mass rapid transit stations. Moreover, mass rapid transit systems have not yet covered all of the metropolitan areas. There are still lots of places where people have to otherwise take buses, taxis or drive by themselves to arrive. Riding motorcycles to travel to places at long or medium distances is fast and convenient, and is almost free of traffic jams, but it is very tiring and risky. Where to park the motorcycle to prevent theft is another problem. Therefore, obviously there shall be another traffic and transportation mode in metropolitan areas with heavy population to overcome the shortcomings of the existing mass rapid transit systems and bus transportation networks. And with such a traffic and transportation system, people will no longer need to exhaust themselves riding motorcycles for trips between places at short, medium or long distances.

Thus, the need for improvement still exists.

### SUMMARY OF THE INVENTION

It is therefore one object of the invention to provide a regional electric vehicle sharing and management method comprising allowing a user to log in an electric vehicle renting mobile application of a mobile device by inputting an account number and a password; connecting to a remote system management server; confirming an electric vehicle to rent by using the mobile device to scan the QR code of the electric vehicle or by inputting a serial number of the electric vehicle; submitting an electric vehicle renting request to the remote system management server; causing the remote system management server to confirm a member identity; using permission and credit data based on a count number and a password entered by a user when logging into a regional electric vehicle sharing and management system wherein if the permission and credit data does not contain any debt record or is not abnormal, and a usage status of the electric vehicle is “authorization required”, the remote system management server accepts the electric vehicle renting request, and change the usage status of the electric vehicle from “authorization required” to “renting approved”, and the remote system management server connects a vehicle control system of the electric vehicle to open a compartment of the electric vehicle, activate a power drive of the electric vehicle, and unlock tires of the electric vehicle so that the user starts the electric vehicle; after arriving at a destination, causing the vehicle control system of the electric vehicle to connect and notify the remote system management server to complete an electric vehicle returning procedure; causing the remote system management server to connect to the electric vehicle renting mobile application of the mobile device to send a message to notify the user that the electric vehicle returning procedure is completed, and provide a detailed list of an electric vehicle rental expenses; causing the remote system management server to connect to the vehicle control system which controls the electric vehicle to shut down the power drive controller of the electric vehicle, lock the tire of the electric vehicle, and change the usage status of the electric vehicle from “renting approved” to “authorization required”; with respect to the electric vehicles with the usage status being “authorization required”, causing the remote system management server, based on coordinate information of vehicle positions returned by the vehicle control systems of the electric vehicles, to confirm the number of available electric vehicles in different regions; causing the remote system management server to initiate a trans-regional electric vehicle renting promotion with area, time and quantitative restrictions, offer low-rate or free-of-charge renting privileges for areas with a plurality of available electric vehicles, and send a notification message of the trans-regional electric vehicle renting promotion to the electric vehicle renting mobile application of the mobile devices belonging to all of a plurality of system members so that the number of the electric vehicles in different regions is configured to be adjusted; with respect to the usage status of the electric vehicle being “renting approved” and a power storage level of in-use batteries of the electric vehicle detected by the remote system management server being lower than a system default value, connecting to the electric vehicle renting mobile application of the mobile device to send a notification message to remind the user that the power storage level of the in-use batteries is too low; based on the coordinate information of the location of the electric vehicle, displaying locations and a map of nearby battery exchange devices for battery replacement; with respect to the power storage level of the in-use batteries of the electric vehicle detected by the remote system management server being lower than the system default value, connecting the vehicle control system of the electric vehicle to display a notification message on a screen of the electric vehicle, turn on a warning light or send a voice indication to remind the user that the power storage level of the in-use batteries is too low, and, based on the coordinate information of the location of the electric vehicle, display locations and a map of nearby battery exchange devices for battery replacement; after arriving at the location of the battery exchange device, removing the in-use batteries with the power storage level lower than the system default value, charging same by the battery exchange device, and placing same in the electric vehicle after charging; with respect to the electric vehicle being rode, causing the vehicle control system of the electric vehicle to transmit the coordinate information of the location and a traveling path of the electric vehicle to the remote system management server; causing the remote system management server to check the coordinate information of the location of the electric vehicle; if the location of the electric vehicle not in the restricted area for the electric vehicle to travel, connecting the remote system management server to the vehicle control system which controls the electric vehicle to shut down the power drive controller of the electric vehicle, display a notification message on the screen of the electric vehicle, turn on a warning light, and send a reminding voice message; connecting the remote system management server to the electric vehicle renting mobile application of the mobile device to send a notification message to warn that the electric vehicle rent by the user is beyond the restricted area; after the user driving the electric vehicle back to the restricted area for the electric vehicle, connecting the remote system management server to the vehicle control system which controls the electric vehicle to turn off the warning light, deactivate the voice indication, and start the power drive controller of the electric vehicle again; with respect to the electric vehicle in a “parking” state, causing the vehicle control system of the electric vehicle to send the coordinate information of the location of the electric vehicle to the remote system management server; and in response to the usage status of the electric vehicle detected by the remote system management server being “authorization required”, and the coordinate information of the location of the electric vehicle indicating the current position of the electric vehicle in a deviation range, connecting the remote system management server to the vehicle control system which controls the electric vehicle to display a notification message on the screen of the electric vehicle, turn on a warning light, and sending a reminding voice message.

The above and other objects, features and advantages of the invention will become apparent from the following detailed description taken with the accompanying drawings.

### BRIEF DESCRIPTION OF THE DRAWINGS

FIG. 1 schematically depicts a regional electric vehicle sharing and management system of the invention.

### DETAILED DESCRIPTION OF THE INVENTION

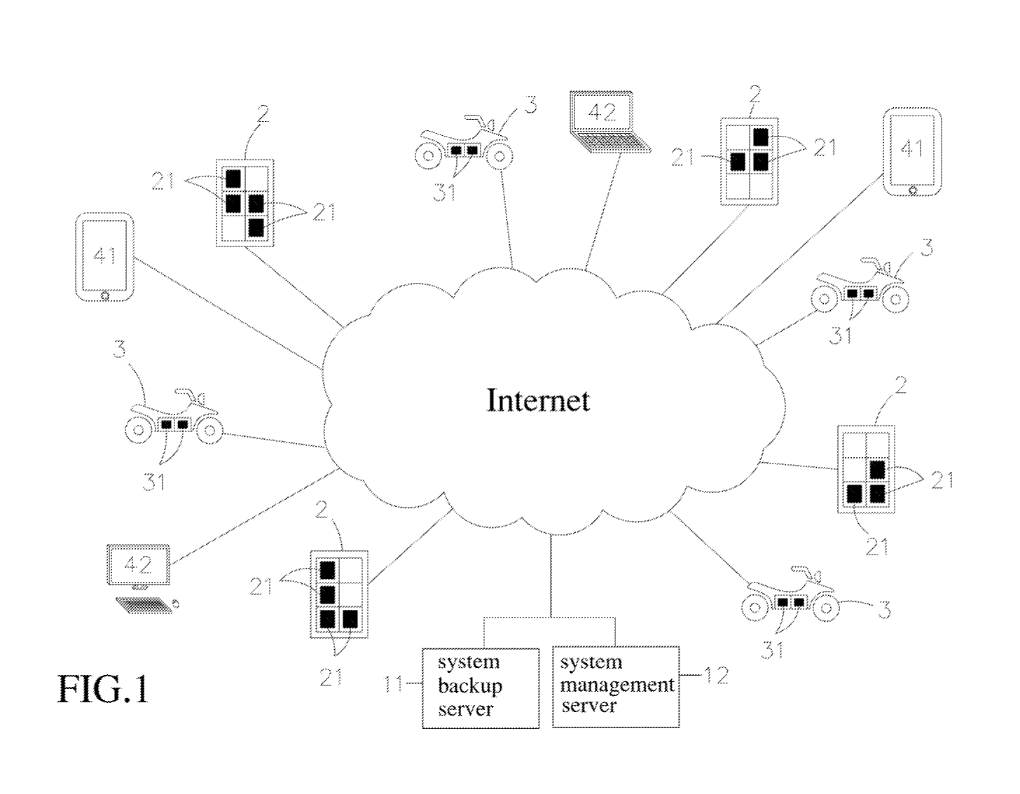

Referring to FIG. 1, a regional electric vehicle sharing and management system of the invention is shown. The regional electric vehicle sharing and management system comprises a system management server 11, a system backup server 12, a plurality of mobile devices 41, a plurality of computers 42, a plurality of battery exchange devices 2, and a plurality of electric vehicles 3.

The system management server 11 and the system backup server 12 are connected to each other via an Intranet, and can have access the Internet via an Intranet. The mobile devices 41 can have access the Internet via a telecommunications network or a wireless network. The computers 42 can have access the Internet via a wired network or a wireless network. The battery exchange device 2 includes a plurality of batteries, a charging circuit and a power monitoring system, they are electrically connected to each other; and the batteries are respectively mounted in the charging circuit to supply supplementary power. The batteries are charged batteries 21.

The power monitoring system is provided with a microcontroller, a GPS (Global Positioning System) tracker and a wireless telecommunication device they are electrically connected to each other. The microcontroller is used for corresponding to control settings and data transmissions. The GPS tracker is used to obtain the coordinate information of the position where the battery exchange devices 2 are mounted. The wireless telecommunication device can have access the Internet via a telecommunications network.

The electric vehicle 3 includes a plurality of batteries and vehicle control systems they are electrically connected to each other. The batteries mounted inside the vehicles are connected to each other through a parallel power supply to supply power to drive the electric vehicles 3 to travel or to supply power for operation of the vehicle control systems. They are in-use batteries 31. The electric vehicle 3 can also be mounted with just one battery to supply power.

The vehicle control system is provided with a microcontroller, a GPS tracker and a wireless telecommunication device they are electrically connected to each other. The microcontroller is used for corresponding to control settings and data transmissions; the GPS tracker is used to obtain the coordinate information of the vehicle location or traveling path of the electric vehicle 3; and the wireless telecommunication device can have access the Internet via a telecommunication network.

The system management server 11, the system backup server 12, the battery exchange devices 2, the electric vehicles 3, the mobile devices 41 or the computers 42 can be connected to each other via the Internet for data transmission. The system backup server 12 is to back up the data of the system management server 11 via the Internet in a real-time manner, either regularly or irregularly. The battery exchange device 2 is capable of GPS positioning or monitoring the power storage level of the charged batteries 21 through the power monitoring system, and can transmit the detected coordinate information of the position of the battery exchange device 2 or the detected power storage level of the charged batteries 21 to the remote system management server 11 through the wireless telecommunication device of the power monitoring system connected to the Internet.

Through the vehicle control system, the electric vehicle 3 is capable of driving power control, motor settings control, GPS tracking, monitoring of the traveling data and power storage level of the in-use batteries 31 as well as control of screen signals, warning light, indicating voice messages, and warning alarms, and can transmit the detected coordinate information of the vehicle location or traveling path of the electric vehicle 3, the traveling data, the detected power storage level of the in-use batteries 31 to the remote system management server 11 in a real-time manner, through the wireless telecommunication device of the vehicle control system connected to the Internet.

The mobile device 41 can be installed with an electric vehicle renting mobile application to access the remote system management server 11 via the Internet, so that the user can conduct data entry and related settings for the renting of the electric vehicle 3 through the electric vehicle renting mobile application; the computer 42 can be installed with an electric vehicle renting computer application to access the system management server 11 via the Internet, so that the user can conduct data entry and related settings for the renting of the electric vehicle 3 through the electric vehicle renting computer application.

A regional electric vehicle sharing and management method tied to the regional electric vehicle sharing and management system comprises user logging into the electric vehicle renting mobile application of the mobile device 41 by inputting account number and password, and connecting to the remote system management server 11, confirming the electric vehicle 3 to rent by using the mobile device 41 to scan the Quick Response Code (QR code) of the electric vehicle 3 or by inputting the serial number of the electric vehicle 3, and submit an electric vehicle renting request to the remote system management server 11; the remote system management server 11 confirming the member identity, using permission and credit data based on the account number and password entered by the user when logging into the system; specifically, if the credit data of the user does not contain any debt record or is not abnormal, and the usage status of the electric vehicle 3 is “authorization required”, the remote system management server 11 will accept the electric vehicle renting request, and change the usage status of the electric vehicle 3 from “authorization required” to “renting approved”; and the remote system management server 11 will connect the vehicle control system controlling the electric vehicle 3 to open the compartment of the electric vehicle 3, activate the power drive of the electric vehicle 3, and unlock the tires of the electric vehicle 3, so that the user can take the car key placed inside the compartment and start the electric vehicle 3 for a ride.

When the user rides the electric vehicle 3 and arrives at the destination, he/she only needs to park the electric vehicle 3 properly and put the key back to the original position inside the vehicle and shut up the compartment, the vehicle control system of the electric vehicle 3 will connect and notify the remote system management server 11 to complete the electric vehicle returning procedure; meanwhile, the remote system management server 11 will also connect the electric vehicle renting mobile application on the user's mobile device 41 to send a message to notify the user that the electric vehicle returning procedure is completed, and to provide a detailed list of the electric vehicle rental expenses. Also, it will connect the vehicle control system that controls the electric vehicle 3 to shut down the power drive controller of the electric vehicle 3 and lock the tire of the electric vehicle 3, and change the usage status of the electric vehicle 3 from “renting approved” to “authorization required”.

For those electric vehicles 3 with their status being “authorization required”, the remote system management server 11 will, based on the coordinate information of the vehicle positions returned by the vehicle control systems of the electric vehicles 3, confirm the number of available electric vehicles 3 distributed in different regions; and the remote system management server 11 can, initiate a trans-regional electric vehicle renting promotion with area, time and quantitative restrictions, offering low-rate or free-of-charge renting privileges for those areas with a large number of available electric vehicles 3, and a notification message of the trans-regional electric vehicle renting promotion can be sent to the electric vehicle renting mobile application on the mobile devices 41 of all the system members; in this way, a large number of system member users will be attracted in a short time to rent the electric vehicles 3 for trans-regional usage, and the number of electric vehicles 3 among different regions can be adjusted and balanced in a short time, saving extra effort to allocate the number of electric vehicles 3.

When the usage status of the electric vehicle 3 is “renting approved”, if the remote system management server 11 detects that the power storage level of the in-use batteries 31 of the electric vehicle 3 is lower than the system default value, it will connect the electric vehicle renting mobile application on the user's mobile device 41 to send a notification message to remind the user that the power storage level of the in-use batteries 31 is too low, and, based on the coordinate information of the location of the electric vehicle 3, it will display the locations and a map of nearby battery exchange devices 2 for battery replacement; or, if the remote system management server 11 detects that the power storage level of the in-use batteries 31 of the electric vehicle 3 is lower than the system default value, it will connect the vehicle control system of the electric vehicle 3, to display a notification message on the screen of the electric vehicle 3, initiate a warning light or a voice indication to remind the user that the power storage level of the in-use batteries 31 is too low, and, based on the coordinate information of the location of the electric vehicle 3, it will display the locations and a map of nearby battery exchange devices 2 for battery replacement.

When the user rides the electric vehicle 3 and arrives at the location of the battery exchange device 2, he/she just needs to take out the in-use batteries 31 with power storage level lower than the system default value or all of the in-use batteries 31 mounted in the vehicle and mount them into the charging circuit of the battery exchange device 2, and then take out the charged batteries 21 from the charging circuit and mount them into the electric vehicle 3. This completes the battery exchanging procedure.

While the user is riding the electric vehicle 3, the vehicle control system of the electric vehicle 3 will continuously transmit the coordinate information of the location and traveling path of the electric vehicle 3 in a real-time manner to the remote system management server 11; and the remote system management server 11 will check and compare the coordinate information of the location of the electric vehicle 3, if it goes beyond the restricted area for the electric vehicle 3 to travel, the remote system management server 11 will connect the vehicle control system that controls the electric vehicle 3 to shut down the power drive controller of the electric vehicle 3, so that the electric vehicle 3 will lose power for traveling, meanwhile, the screen of the electric vehicle 3 will display a notification message, initiate a warning light, a reminding voice message or repeated warning alarms; meanwhile, the remote system management server 11 will also connect the electric vehicle renting mobile application on the user's mobile device 41 to send a notification message to remind and warn that the electric vehicle 3 rent by the user is going beyond the restricted area.

When the user moves the electric vehicle 3 back to the restricted area for the electric vehicle 3 to travel, the remote system management server 11 will connect the vehicle control system that controls the electric vehicle 3 to shut off the warning light, the indicating voice and the warning alarms, and start the power drive controller of the electric vehicle 3 again, so that the electric vehicle 3 can be powered to travel.

When the electric vehicle 3 is in a static “parking” state, the vehicle control system of the electric vehicle 3 will still send the coordinate information of the location of the electric vehicle 3 to the remote system management server 11 in a real-time manner; if the remote system management server 11 detects that the usage status of the electric vehicle 3 is “authorization required”, while the coordinate information of the location of the electric vehicle 3 is going beyond the preset allowable position deviation range or is in a continuous motion, the remote system management server 11 will connect the vehicle control system that controls the electric vehicle 3, to display on the screen of the electric vehicle 3 a notification message, and initiate a warning light, a reminding voice or repeated warning alarms.

The invention enables the user to access the remote system management server 11 through the electric vehicle renting program installed on the mobile device 41 or the computer 42, to conduct data entry and related settings for the renting of the electric vehicles. Thus, the convenience and rate of usage of the electric vehicle renting can be greatly enhanced, offering a fast and convenient mass transportation method that features low establishment cost and easy maintenance and management. Meanwhile, it is capable of allocation and dispatching of electric vehicles among different regions with time and quantitative restrictions by offering users free-of-charge or low-rate renting privileges, so that, during a specific period, many users will be attracted to use the electric vehicle renting. As a result, electric vehicles can be allocated or dispatched among different regions without the need to assign or employ extra human resources, or the extra need to transport vehicles.

While the invention has been described in terms of preferred embodiments, those skilled in the art will recognize that the invention can be practiced with modifications within the spirit and scope of the appended claims.

What is claimed is:

1. A regional electric vehicle sharing and management method comprising the steps of:
allowing a user to log in an electric vehicle renting mobile application of a mobile device by inputting an account number and a password;
connecting to a remote system management server;
confirming an electric vehicle to rent by using the mobile device to scan the QR code of the electric vehicle or by inputting a serial number of the electric vehicle;
submitting an electric vehicle renting request to the remote system management server;
causing the remote system management server to confirm a member identity;
using permission and credit data based on a count number and a password entered by a user when logging into a regional electric vehicle sharing and management system wherein if the permission and credit data does not contain any debt record or is not abnormal, and a usage status of the electric vehicle is “authorization required”, the remote system management server accepts the electric vehicle renting request, and change the usage status of the electric vehicle from “authorization required” to “renting approved”, and the remote system management server connects a vehicle control system of the electric vehicle to open a compartment of the electric vehicle, activate a power drive of the electric vehicle, and unlock tires of the electric vehicle so that the user starts the electric vehicle;
after arriving at a destination, causing the vehicle control system of the electric vehicle to connect and notify the remote system management server to complete an electric vehicle returning procedure;
causing the remote system management server to connect to the electric vehicle renting mobile application of the mobile device to send a message to notify the user that the electric vehicle returning procedure is completed, and provide a detailed list of an electric vehicle rental expenses;
causing the remote system management server to connect to the vehicle control system which controls the electric vehicle to shut down the power drive controller of the electric vehicle, lock the tire of the electric vehicle, and change the usage status of the electric vehicle from “renting approved” to “authorization required”;
with respect to the electric vehicles with the usage status being “authorization required”, causing the remote system management server, based on coordinate information of vehicle positions returned by the vehicle control systems of the electric vehicles, to confirm the number of available electric vehicles in different regions;
causing the remote system management server to initiate a trans-regional electric vehicle renting promotion with area, time and quantitative restrictions, offer low-rate or free-of-charge renting privileges for areas with a plurality of available electric vehicles, and send a notification message of the trans-regional electric vehicle renting promotion to the electric vehicle renting mobile application of the mobile devices belonging to all of a plurality of system members so that the number of the electric vehicles in different regions is configured to be adjusted;
with respect to the usage status of the electric vehicle being “renting approved” and a power storage level of in-use batteries of the electric vehicle detected by the remote system management server being lower than a system default value, connecting to the electric vehicle renting mobile application of the mobile device to send a notification message to remind the user that the power storage level of the in-use batteries is too low;
based on the coordinate information of the location of the electric vehicle, displaying locations and a map of nearby battery exchange devices for battery replacement;
with respect to the power storage level of the in-use batteries of the electric vehicle detected by the remote system management server being lower than the system default value, connecting the vehicle control system of the electric vehicle to display a notification message on a screen of the electric vehicle, turn on a warning light or send a voice indication to remind the user that the power storage level of the in-use batteries is too low, and, based on the coordinate information of the location of the electric vehicle, display locations and a map of nearby battery exchange devices for battery replacement;
after arriving at the location of the battery exchange device, removing the in-use batteries with the power storage level lower than the system default value, charging same by the battery exchange device, and placing same in the electric vehicle after charging;
with respect to the electric vehicle being rode, causing the vehicle control system of the electric vehicle to transmit the coordinate information of the location and a traveling path of the electric vehicle to the remote system management server;
causing the remote system management server to check the coordinate information of the location of the electric vehicle;
if the location of the electric vehicle not in the restricted area for the electric vehicle to travel, connecting the remote system management server to the vehicle control system which controls the electric vehicle to shut down the power drive controller of the electric vehicle, display a notification message on the screen of the electric vehicle, turn on a warning light, and send a reminding voice message;
connecting the remote system management server to the electric vehicle renting mobile application of the mobile device to send a notification message to warn that the electric vehicle rent by the user is beyond the restricted area;
after the user driving the electric vehicle back to the restricted area for the electric vehicle, connecting the remote system management server to the vehicle control system which controls the electric vehicle to turn off the warning light, deactivate the voice indication, and start the power drive controller of the electric vehicle again;
with respect to the electric vehicle in a “parking” state, causing the vehicle control system of the electric vehicle to send the coordinate information of the location of the electric vehicle to the remote system management server; and
in response to the usage status of the electric vehicle detected by the remote system management server being “authorization required”, and the coordinate information of the location of the electric vehicle indicating the current position of the electric vehicle in a deviation range, connecting the remote system management server to the vehicle control system which controls the electric vehicle to display a notification message on the screen of the electric vehicle, turn on a warning light, and sending a reminding voice message.
